(19) United States
(12) Patent Application Publication
(10) Pub. No.: US 2022/0070801 A1
(43) Pub. Date: Mar. 3, 2022

(54) MONITORING SYSTEM AND SYNCHRONIZATION METHOD

(71) Applicant: NEC Corporation, Minato-ku, Tokyo (JP)

(72) Inventor: Tadashi SATOH, Tokyo (JP)

(73) Assignee: NEC Corporation, Minato-ku, Tokyo (JP)

(21) Appl. No.: 17/421,526

(22) PCT Filed: Dec. 20, 2019
(86) PCT No.: PCT/JP2019/050088

§ 371 Date: Jul. 8, 2021

(30) Foreign Application Priority Data
Jan. 16, 2019 (JP) 2019-005350

(51) Int. Cl. H04W 56/00; G01D 21/02

(52) U.S. Cl. CPC H04W 56/001; H04W 88/16; G01D 21/02

(57) ABSTRACT

A monitoring system includes: sensor nodes installed on a structure and configured to measure physical quantities of the structure; and a gateway apparatus connected to the sensor nodes. The gateway apparatus includes: a synchronization packet transmission unit transmitting a synchronization packet specifying synchronization time and measurement start time, to the sensor nodes by broadcast communication; and a correction unit correcting each of measured values of the sensor nodes. The sensor node includes: a synchronization unit synchronizing time in the sensor node with the synchronization time indicated in the synchronization packet; a difference calculation unit calculating a time synchronization difference which is a difference between the time in the sensor node before the synchronization and the synchronization time; a measurement unit starting measurement of the physical quantities at the measurement start time; and a correction information transmission unit transmitting the time synchronization difference and a measured value to the correction unit.

### TECHNICAL FIELD

The present disclosure relates to a monitoring system and a synchronization method, and in particular to a monitoring system and a synchronization method using a wireless network.

### BACKGROUND ART

Deterioration of road infrastructure developed by concentrated investment during the high economic growth period has been a serious social problem, and social implementation of a monitoring system utilizing IT technology is being promoted for the purpose of improving efficiency of maintenance and management.

In such a monitoring system, various kinds of sensors are used. For example, as a representative sensor for monitoring change in physical characteristics of a bridge, there is a vibration sensor. In the case of arranging vibration sensors at a plurality of positions on a monitoring target structure to analyze phase information of acquired vibration data, it is necessary that pieces of vibration data acquired from the plurality of positions are synchronized.

Patent Literature 1 discloses a technique that enables time synchronization by, without using a time synchronization server, developing other time information obtained by clocking among network terminals, among the terminals.

### CITATION LIST

### Patent Literature

Patent Literature 1: International Patent Publication No. WO2010/116968

### SUMMARY OF INVENTION

### Technical Problem

In the case of collecting sensor data from sensors installed at a plurality of positions on a structure, it is effective to use a wireless network using specific low-power radio from a viewpoint of installation cost and the like. However, when time synchronization is performed by one-to-one communication between a gateway and sensor nodes using a wireless network by specific low-power radio, there is a problem that fluctuation of communication completion time occurs due to a packet retransmission process and the like that occur when the wireless communication state is bad (radio wave collision with other communications, radio waves temporarily not reaching a sensor node, and the like), and synchronization accuracy decreases.

The present invention has been made to solve such a problem, and aims to provide a monitoring system and a synchronization method in which synchronization accuracy of sensors is improved even when a wireless network is used.

### Solution to Problem

A monitoring system according to a first aspect of the present invention includes:

a plurality of sensor nodes installed on a structure and configured to measure physical quantities of the structure; and

a gateway apparatus communicably connected to the plurality of sensor nodes via a wireless network,

the gateway apparatus including:

a synchronization packet transmission unit configured to transmit a synchronization packet specifying synchronization time and measurement start time, to the plurality of sensor nodes by broadcast communication; and

a correction unit configured to correct each of measured values measured by the plurality of sensor nodes,

each of the plurality of sensor nodes including:

a synchronization unit configured to synchronize time in the sensor node with the synchronization time indicated in the received synchronization packet;

a difference calculation unit configured to calculate a time synchronization difference which is a difference between the synchronization time indicated in the received synchronization packet and the time in the sensor node before the synchronization;

a measurement unit configured to start measurement of the physical quantities at the measurement start time of the synchronization packet; and

a correction information transmission unit configured to transmit the time synchronization difference and a measured value measured by the measurement unit to the correction unit of the gateway apparatus, wherein

the correction unit corrects the measured value based on the time synchronization difference, for each sensor node.

A monitoring system according to a second aspect of the present invention includes:

a plurality of sensor nodes installed on a structure and configured to measure physical quantities of the structure;

a gateway apparatus communicably connected to the plurality of sensor nodes via a wireless network; and

an analysis server connected to the gateway apparatus via a network,

the gateway apparatus including

a synchronization packet transmission unit configured to transmit a synchronization packet specifying synchronization time and measurement start time, to the plurality of sensor nodes by broadcast communication,

each of the plurality of sensor nodes including:

a synchronization unit configured to synchronize time in the sensor node with the synchronization time indicated in the received synchronization packet;

a difference calculation unit configured to calculate a time synchronization difference which is a difference between the synchronization time indicated in the received synchronization packet and the time in the sensor node before the synchronization;

a measurement unit configured to start measurement of the physical quantities at the measurement start time of the synchronization packet; and

a correction information transmission unit configured to transmit the time synchronization difference calculated by the difference calculation unit and a measured value measured by the measurement unit to the analysis server,

wherein the analysis server includes a correction unit configured to correct the measured value based on the time synchronization difference, for each sensor node.

A synchronization method according to a third aspect of the present invention is a synchronization method of a monitoring apparatus, the monitoring apparatus including:

a plurality of sensor nodes installed on a structure and configured to measure physical quantities of the structure; and

a gateway apparatus communicably connected to the plurality of sensor nodes via a wireless network, wherein

the gateway apparatus transmits a synchronization packet specifying synchronization time and measurement start time, to the plurality of sensor nodes by broadcast communication,

each of the plurality of sensor nodes

synchronizes time in the sensor node with the synchronization time indicated in the received synchronization packet,

calculates a time synchronization difference which is a difference between the synchronization time indicated in the received synchronization packet and the time in the sensor node before the synchronization,

starts measurement of the physical quantities at the measurement start time of the synchronization packet, and

transmits the time synchronization difference and a measured value obtained by the measurement to the gateway apparatus, and

the gateway apparatus corrects the measured value based on the time synchronization difference, for each sensor node.

### Advantageous Effects of Invention

According to the present disclosure, it is possible to provide a monitoring system and a synchronization method in which synchronization accuracy of sensors is improved.

### BRIEF DESCRIPTION OF THE DRAWINGS

FIG. 1 is a block diagram showing a configuration example of a monitoring system 1 using a specific low-power wireless network according to a first example embodiment;

FIG. 2 is a flowchart of acquisition of sensor data according to the first example embodiment;

FIG. 3 is a diagram explaining a resampling process according to the first example embodiment;

FIG. 4 is a block diagram showing a configuration example of a monitoring system 1 according to a second example embodiment;

FIG. 5 is a flowchart of acquisition of sensor data according to the second example embodiment;

FIG. 6 is a sensor data acquisition sequence diagram according to the second example embodiment;

FIG. 7 is a diagram explaining sensor node operations according to states of receiving measurement start synchronization packets transmitted three times, according to the second example embodiment; and

FIG. 8 is a block diagram showing a configuration example of a synchronization control system 10 according to a third example embodiment.

### DESCRIPTION OF EXAMPLE EMBODIMENTS

### First Example Embodiment

An example embodiment of the present invention will be described below with reference to drawings.

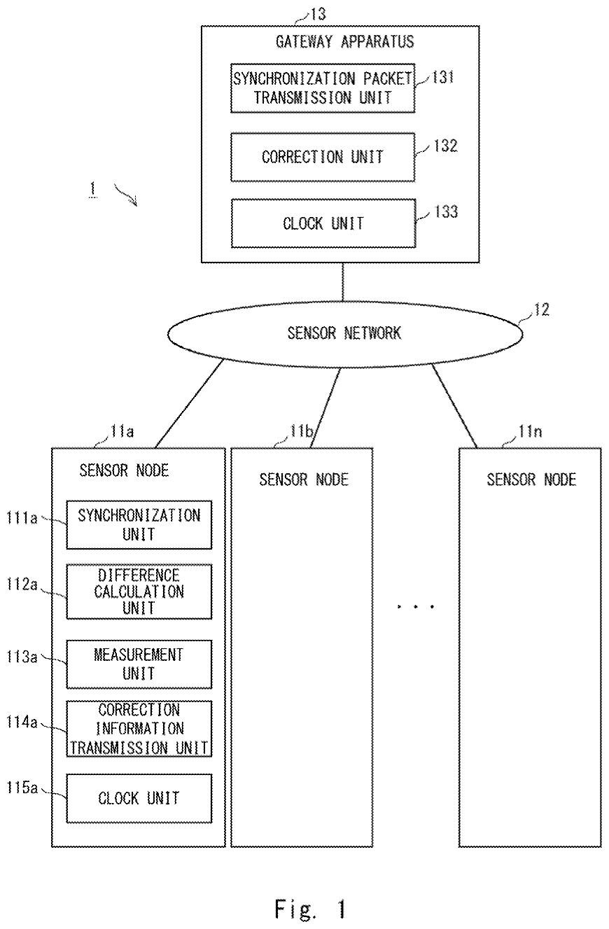

FIG. 1 shows a configuration example of a monitoring system 1 using a specific low-power wireless network. The monitoring system 1 is provided with one or more sensor nodes 11, a wireless network 12 and a gateway apparatus 13. The monitoring system 1 diagnoses soundness, structural performance, a deterioration state and the like of a structure by receiving sensor data from the plurality of sensor nodes 11a, 11b, . . . , 11n installed on the structure. Here, as the structure, a road infrastructure (especially a bridge), a railroad iron bridge, a steel tower for power, a wireless antenna or the like, a construction such as a building, road incidental equipment such as a traffic sign are given, but the structure is not limited thereto.

On such a structure, the plurality of sensor nodes 11a, 11b, . . . , 11n for detecting physical quantities and the like of the structure are installed. For example, when the structure vibrates due to an earthquake, the sensor nodes 11 can measure various physical quantities such as the acceleration, tilt, temperature and vibration frequency of, and phase information and position information about the structure.

The gateway apparatus 13 is communicably connected to the plurality of sensor nodes 11a, . . . , 11n via the wireless network 12. In this example, a 920 MHz band specific low-power wireless network is used as a sensor network. Further, it is assumed that the sensor nodes 11 do not perform multi-hop communication, for low power consumption and minimization of wireless communication time lag.

In the case of desiring to acquire signals of sensors connected to a plurality of nodes among the nodes with a synchronization accuracy within 1 ms, in a sensor system using a specific low-power wireless network, it is difficult to realize the desire because of influence of loss of a wireless communication packet, the operating clock accuracy of the sensor nodes (in the case of using a crystal oscillator, generally, about ±15 ppm for a narrow deviation type) and the like. Therefore, until now, sensor signals are synchronized with a high accuracy by implementing a GPS module, an atomic clock and the like for each sensor node and using highly accurate time information. However, since the GPS module and the atomic clock are expensive and are required in proportion to the number of sensor nodes, there is a problem that cost of the monitoring system increases. Therefore, in the present example embodiment, such a problem is solved by a gateway apparatus transmitting a synchronization packet to each sensor node.

The gateway apparatus 13 includes a control unit configured with a CPU (central processing unit), a memory, an input/output port and the like, and the control unit is also responsible for functions as functional arithmetic units that execute subdivided processes, respectively. Specifically, the control unit of the gateway apparatus 13 includes a synchronization packet transmission unit 131 that transmits a synchronization packet specifying synchronization time and measurement start time to the plurality of sensor nodes 11a, . . . , 11n by broadcast communication, a correction unit 132 that corrects each of times of pieces of measured data from the plurality of sensor nodes 11a, . . . , 11n, and a clock unit 133. Though the clock unit 133 of the gateway apparatus 13 has a crystal oscillator, it may include a GPS module and an atomic clock if higher precision and accuracy are required.

Each of the plurality of sensor nodes 11 includes a control unit configured with a CPU, a memory, an input/output port and the like, and the control unit is also responsible for functions as functional arithmetic units that execute subdivided processes, respectively. Specifically, the control unit of the sensor node 11a includes a synchronization unit 111a, a difference calculation unit 112a, a measurement unit 113a, a correction information transmission unit 114a and a clock unit 115a. The synchronization unit 111a synchronizes time of the sensor node with synchronization time indicated in a received synchronization packet.

The difference calculation unit 112a calculates a time synchronization difference, which is a difference between the synchronization time indicated in the received synchronization packet and time in the sensor node 11a before synchronization. The measurement unit 113a starts measurement of physical quantities at measurement start time indicated in the synchronization packet. The correction information transmission unit 114a transmits the time synchronization difference calculated by the difference calculation unit 112a and measured values measured by the measurement unit 113a to the correction unit 132 of the gateway apparatus 13.

The sensor nodes 11b, . . . , 11n are configured similarly to the sensor node 11a though it is not shown in the drawing for simplification of explanation.

The correction unit 132 can correct measured values from the plurality of sensor nodes 11a, 11b, . . . , 11n based on time synchronization differences.

As explained above, according to the present example embodiment, it is possible to acquire sensor data with a high synchronization accuracy.

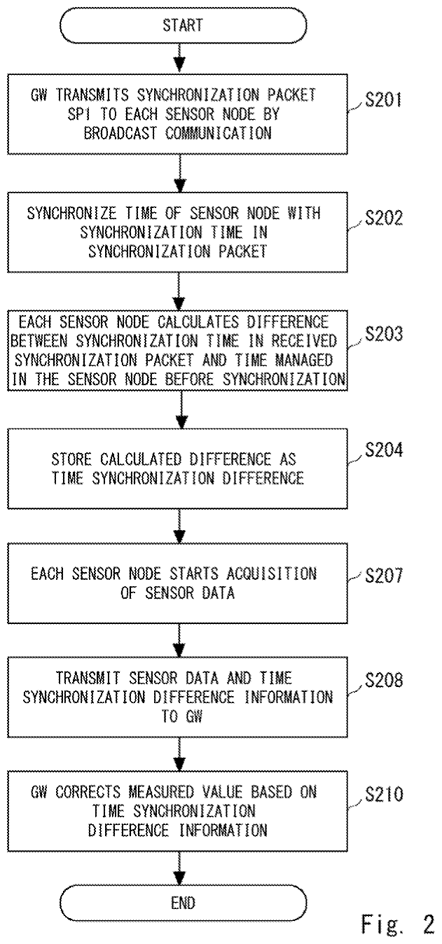

Next, a sensor data acquisition process flow according to the present example embodiment will be explained in detail with reference to FIGS. 1 and 2.

Before start of measurement of sensors, the gateway apparatus 13 transmits a synchronization packet SP instructing each of the sensor nodes 11a, 11b, . . . , 11n by broadcast communication to start measurement (step S201). The synchronization packet includes information on synchronization time (ex. 12:30.000) for time synchronization and measurement start time (ex. 12:30.600). As described later, the gateway apparatus 13 transmits the synchronization packet SP by broadcast communication each time it instructs each of the sensor nodes 11a, 11b, . . . , 11n to measure physical quantities (acquire sensor data).

Each of the sensor nodes 11a, 11b, . . . , 11n synchronizes time managed in the sensor node with the synchronization time (ex. 12:30.000) in the received synchronization packet SP (step S202). Thereby, a difference between the “synchronization time” information included in the synchronization packet received from the gateway apparatus 13 and the “time” information managed by each of the sensor nodes 11a, 11b, . . . , 11n becomes zero (the pieces of information correspond to each other). That is, at this point of time, the times of the sensor nodes are synchronized with a high accuracy.

However, the sensor nodes use a specific low-power wireless network to communicate with the gateway apparatus 13 as described above, and, therefore, in the case of a bad communication state, synchronization accuracy decreases due to occurrence of fluctuation of communication completion time and occurrence of variation in the way of time advancing among the sensor nodes. Therefore, in the present example embodiment, these problems are coped with, by transmitting a synchronization packet for the fluctuation in communication and performing calibration using difference information at the time of time synchronization for the variation among clocks in the sensor nodes. A specific procedure will be explained below.

Each of the difference calculation units 112 of the sensor nodes 11 calculates a difference between the “synchronization time” information included in the synchronization packet SP received from the gateway apparatus 13 and the “time” information managed by each sensor node before the synchronization process (step S202) (step S203), and the differences are stored as time synchronization differences TDa, TDb, . . . , TDn (step S204).

Each of the sensor nodes 11a, 11b, . . . , 11n starts acquisition of a sensor signal at the measurement start time according to the synchronization packet received from the gateway apparatus 13 (step S207). Since the synchronization packet SP shows measurement start time T4 (12:30.600) as described above, each sensor node starts measurement at the same time T4 (12:30.600) on the clock unit 115 of the sensor node when receiving the synchronization packet SP sent by broadcast communication.

At a point of time when acquisition of sensor data corresponding to a measurement time determined in advance is completed, each sensor node ends acquisition of sensor data. For example, when sensor data is acquired for a measurement time of thirty seconds at a sampling period of 400 Hz, pieces of sensor data acquired at the sensor node 11a are called Dₐ₀, Dₐ₁, Dₐ₂, . . . , D_{aN} at the clock unit 115 of each sensor node 11a. After that the sensor node 11a transmits the acquired pieces of sensor data (Dₐ₀, Dₐ₁, Dₐ₂, . . . , D_{aN}) and time synchronization difference information (TDa) to the gateway apparatus 13 at a timing specified for each sensor node. It is assumed that the same goes for the other sensor nodes 11b, . . . , 11n (step S208).

The gateway apparatus 13 analyzes the pieces of sensor data collected from the sensor node 11a. At that time, as for the sensor node 11a, by dividing the time synchronization difference (TDa) by a time from the previous synchronization time to the current synchronization time (synchronization interval time STa; also referred to as a measurement time interval because a synchronization packet is sent for each measurement), the gateway apparatus 13 calculates an error per unit time EDa (=TDa/STa). By multiplying the error EDa by a sensor data measurement time MT, a value of time deviation occurred in the clock unit in the sensor node 11a during measurement, ETa (=EDa×MT) can be estimated.

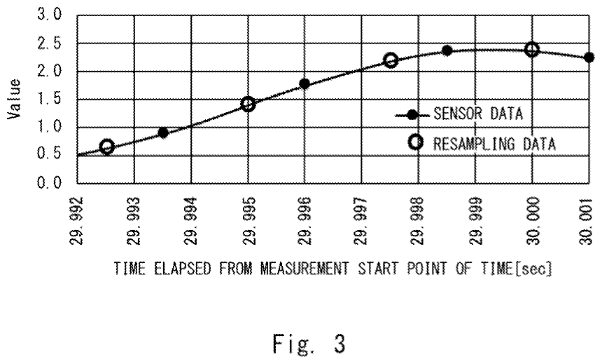

Here, explanation will be made on a case where the sampling frequency is 400 Hz, and the measurement time is thirty seconds as an example. If ETa described above is 1 ms, the measurement timing of the last measured value is a value measured after 30.001 seconds from the measurement start point of time. In this example, the time from the time of receiving the synchronization packet to the measurement start time is 600 ms, which is a very short time. Therefore, time deviation that occurs during the period can be ignored. The time of the clock unit in the sensor node immediately after start of measurement is synchronized with a high accuracy; time of acquiring the last sensor data can be estimated; and sensor data acquisition intervals can be estimated to be regular intervals without being influenced by time deviation of the sensor node. From these, by performing a resampling process as shown in FIG. 3, it is possible to calculate values of sensor data synchronized with a high accuracy.

Similarly, the gateway apparatus 13 corrects and analyzes sensor data (D_{b0}, D_{b1}, D_{b2}, . . . , D_{bN}, . . . , Dₙ₀, Dₙ₁, Dₙ₂, . . . , D_{nN}) collected from the sensor nodes 11b, . . . , 11n. A specific method is similar to the case of the sensor node 11a described above.

As described above, the gateway apparatus is capable of, after correcting synchronization deviation of sensor data of each sensor node, processing the corrected data as synchronized sensor data.

Here, “time synchronization difference/synchronization interval time” will be explained in detail.

For example, a case where sensor data is collected for thirty seconds at one-hour intervals will be explained as an example. The “time synchronization difference” collected from each sensor when a synchronization process is performed by the method of the present invention is a difference between time of the gateway apparatus and time on each sensor node side that has occurred within one hour after time synchronization performed after receiving the previous synchronization packet.

As one of main causes of fluctuation of the way of time advancing in the sensor nodes, influence by surrounding temperature is conceivable. Since it is rare that temperature significantly changes within one hour, an amount of time difference per unit seconds is “time synchronization difference/(60×60)” (seconds). By multiplying this time synchronization difference per unit seconds by measurement time (thirty seconds), an amount of correction can be calculated. Since it becomes possible to estimate the amount of time difference that occurs in thirty seconds from start of measurement to end of the measurement, for each sensor node as described above, it is possible to, by correcting variation in the way of time advancing among the sensor nodes that occurs during measurement with the above estimated value of synchronization difference that occurs in thirty seconds, correct synchronization deviation due to variation among the ways of time advancing in the sensor nodes.

Further, though the case of performing measurement at one-hour intervals is shown in the above example, the above correction becomes possible if time elapsed from the previous measurement is known, and the measurement interval is not required to be constant.

As explained above, according to the present example embodiment, it is possible to acquire sensor data with a high synchronization accuracy.

### Second Example Embodiment

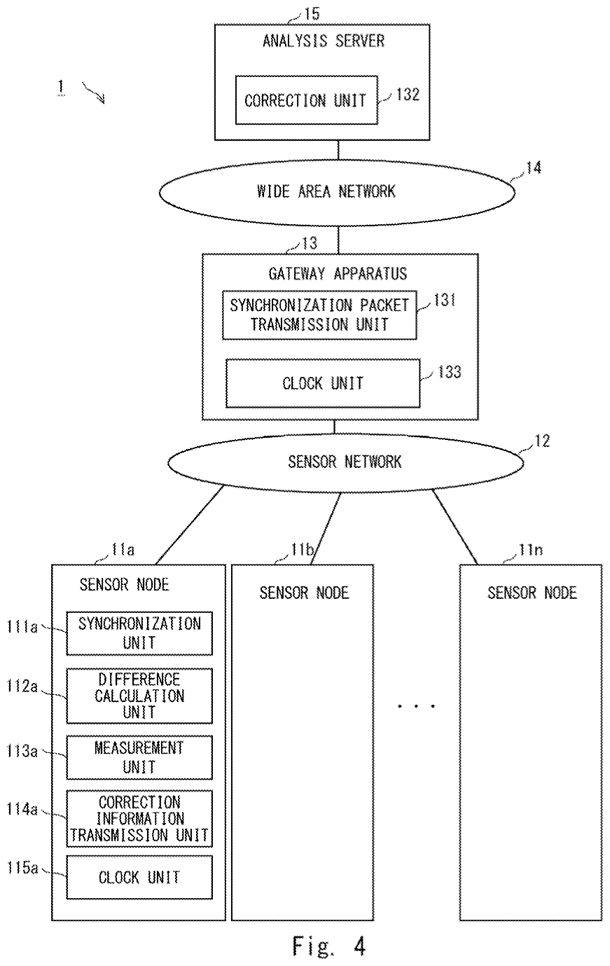

FIG. 4 shows a configuration example of a monitoring system 1 according to a second example embodiment.

In FIG. 4, the same components as the first example embodiment are given the same reference signs as FIG. 1, and description thereof will be appropriately omitted. To the monitoring system 1 shown in FIG. 4, an analysis server 15 for analyzing the sensor data described above is added. The analysis server 15 is connected to the gateway apparatus 13 via a wide area network 14. The wide area network 14 is, for example, an LTE (Long Term Evolution) line provided by a mobile operator. The gateway apparatus 13 can transmit sensor data collected by the sensor nodes 11 to the analysis server 15. In the present example embodiment, the analysis server 15 includes the correction unit 132 described before. That is, in the present example embodiment, the gateway apparatus 13 does not have the correction unit 132 unlike the first example embodiment.

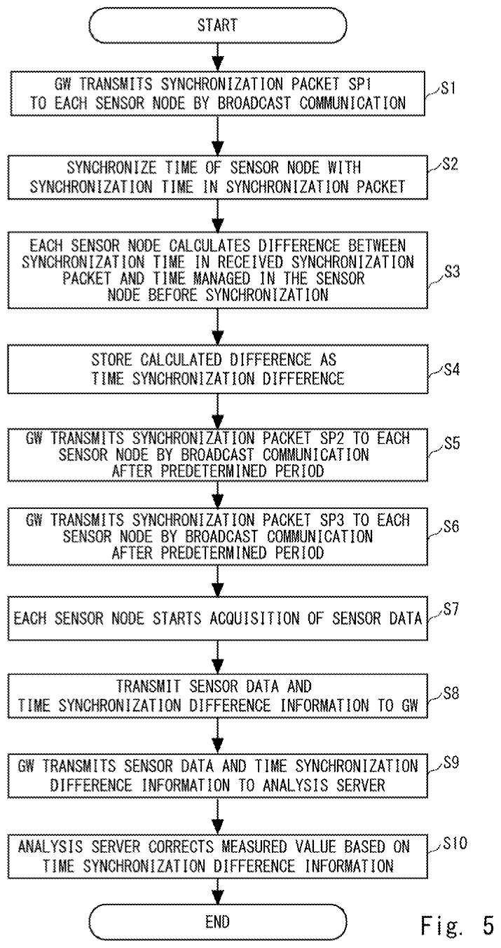

A sensor data acquisition sequence according to the present example embodiment will be described with reference to FIGS. 4 to 7.

Before the sensor nodes start measurement, the gateway apparatus 13 transmits a synchronization packet instructing each of the sensor nodes 11a, 11b, . . . , 11n to start measurement by broadcast communication (step S1). The synchronization packet includes information on synchronization time T₁ (ex. 12:30.000) for time synchronization and measurement start time T₄ (ex. 12:30.600). As described later, the gateway apparatus 13 transmits the synchronization packet SP by broad cast communication each time it instructs each of the sensor nodes 11a, 11b, . . . 11n to measure physical quantities. In the present example embodiment, the synchronization packet is transmitted three times for one measurement start instruction as a measure against packet loss as described later. The number of times of transmitting the synchronization packet is not limited to three times. A predetermined number of times equal to or larger than two is also possible.

When time synchronization is performed by one-to-one communication between a gateway and sensor nodes using a wireless network by specific low-power radio, fluctuation of communication completion time occurs due to a packet retransmission process and the like that occur when the wireless communication state is bad (radio wave collision with other communications, radio waves temporarily not reaching a sensor node, and the like), and, therefore, synchronization accuracy decreases. Further, as for the 920 M band that has been recently often used by wireless sensor networks, carrier sense time is stipulated by a wireless standard (ARIB STD-T108), and it is stipulated to confirm that there are not other radio wave sources before transmission of radio waves (to wait if there is a radio wave source). Therefore, fluctuation of communication time occurs.

In each example embodiment of the present invention, a method of simultaneously transmitting a synchronization packet to a plurality of sensor nodes using a broadcast packet is adopted as a measure against the above. In the case of a broadcast packet, however, there is a problem that a sensor node that cannot receive the packet cannot perform time synchronization. Therefore, in the present example embodiment, the packet loss problem is coped with by transmitting the synchronization packet a plurality of times from a gateway apparatus (details will be described later).

Each of the sensor nodes 11a, 11b, . . . 11n synchronizes time managed in the sensor node with the synchronization time in the received synchronization packet (step S2). Thereby, a difference between “synchronization time” information included in the synchronization packet received from the gateway apparatus 13 and “time” information managed by each of the sensor nodes 11a, 11b, . . . , 11n becomes zero (the pieces of information correspond to each other). That is, at this point of time, the times of the sensor nodes are synchronized with a high accuracy.

However, the sensor nodes use the specific low-power wireless network to communicate with the gateway apparatus 13 as described above, and, therefore, in the case of a bad communication state, fluctuation of communication completion time occurs, variation in the way of time advancing occurs among the sensor nodes, and synchronization accuracy decreases. Therefore, in the present example embodiment, this problem is solved by the following procedure.

The difference calculation unit 112 of each of the sensor nodes 11 calculates a difference between the “synchronization time” information included in the synchronization packet received from the gateway apparatus 13 and the “time” information managed by the sensor node (step S3), and the differences are stored as time synchronization differences TDa, TDb, TDn (step S4).

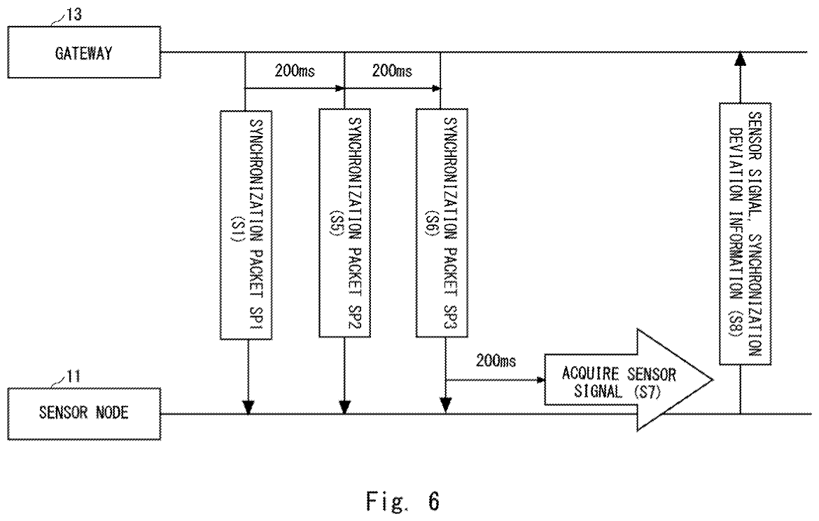

Here, as shown in FIG. 6, the gateway apparatus 13 transmits a synchronization packet SP2 to each sensor node again by broadcast communication after a predetermined period (for example, 200 ms) after the above step S1 (step S5). At this time, it is assumed that synchronization time in the synchronization packet SP2 is T2 (12:30.200), and measurement start time is T4 (12:30.600). Even a sensor node that could not receive the synchronization packet SP1 performs a process similar to the above steps S2, S3 and S4 if the sensor node can receive the synchronization packet SP2 at step S5. It is assumed that, as for a sensor node that has already received the synchronization packet SP1, the sensor node does not perform the process of the above steps S2, S3 and S4 again even if the sensor node receives the synchronization packet SP2 again. In the present example embodiment, though the probability of occurrence of packet loss increases by using a plurality of sensor nodes, influence at the time of occurrence of packet loss is reduced by transmitting a synchronization packet a plurality of times as above.

After a predetermined period (for example, 200 ms) after the above step S5, the gateway apparatus 13 transmits a synchronization packet SP3 again (step S6). At this time, it is assumed that synchronization time in the synchronization packet SP3 is T₃ (12:30.400), and measurement start time is T₄ (12:30.600). Even a sensor node that could receive neither the synchronization packet SP1 nor the synchronization packet SP2 performs a process similar to the above steps S2, S3 and S4 if the sensor node can receive the synchronization packet SP3 at step S6. It is assumed that, as for a sensor node that has already received either the synchronization packet SP1 or SP2, the sensor node does not perform the process of the above steps S2, S3 and S4 again even if the sensor node receives the synchronization packet SP3 again. Thereby, the packet loss problem is similarly coped with.

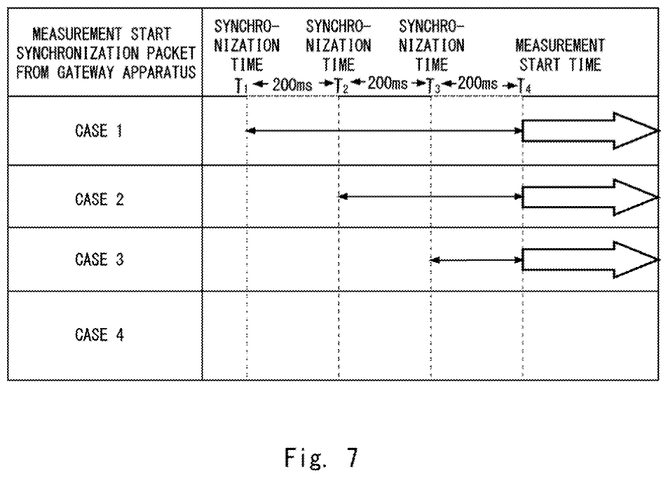

Here, sensor node operations according to states of receiving measurement start synchronization packets transmitted three times will be explained using FIG. 7.

FIG. 7 shows measurement operations of sensor nodes according to cases of states of receiving measurement start synchronization packets from a gateway apparatus. In this example, a measurement start synchronization packet is transmitted from the gateway three times, at times T1, T2 and T3 at intervals of 200 ms. Each measurement start synchronization packet includes information about synchronization time and measurement start time. Each one-way arrow in FIG. 7 indicates that a sensor node is operating for measuring. Case 1 is a case where a sensor node could receive a measurement start synchronization packet SP1. The sensor node sets time of its own using the time information in the measurement start synchronization packet, enters a measurement waiting state until the measurement start time in the measurement start synchronization packet, and starts measurement at the measurement start time. It is assumed that, for a measurement start synchronization packet received during the measurement waiting state, the process related to the measurement start sequence (the above steps S2, S3 and S4) is not performed. Case 2 is a case where the measurement start synchronization packet SP1 could not be received, but SP2 could be received. Case 3 is a case where neither the measurement start synchronization packet SP1 nor SP2 could be received, but SP3 could be received. Case 4 is a case where none of the measurement start synchronization packets SP1, SP2 and SP3 could be received, and, in this case the sensor node does not start measurement.

In the present example embodiment, an example of transmitting a synchronization packet three times for each measurement has been explained. However, without being limited thereto, a synchronization packet may be transmitted three or more times for each measurement.

Each of the sensor nodes 11a, 11b, . . . , 11n starts acquisition of a sensor signal at measurement start time according to the synchronization packet received from the gateway apparatus 13 (step S7). Since all of the synchronization packets SP1, SP2 and SP3 show the same measurement start time T4 (12:30.600) as described above, each sensor node can start measurement at the same time as shown in Cases 1 to 3 in FIG. 7 if receiving any of the synchronization packets SP1, SP2 and SP3. Thereby, it is possible to cope with the packet loss problem.

At a point of time when acquisition of sensor data corresponding to a measurement time determined in advance is completed, each sensor node ends acquisition of sensor data. For example, when sensor data is acquired for a measurement time of thirty seconds at a sampling period of 400 Hz, pieces of sensor data acquired at the sensor node 11a are called Dₐ₀, Dₐ₁, Dₐ₂, . . . , D_{aN} at the clock unit 115 of the sensor node 11a. After that the sensor node 11a transmits the acquired pieces of sensor data (Dₐ₀, Dₐ₁, Dₐ₂, . . . , D_{aN}) and time synchronization difference information (TDa) to the gateway apparatus 13 at a timing specified for each sensor node. It is assumed that the same goes for the other sensor nodes 11b, . . . , 11n (step S8).

Further, if each sensor node also transmits information about the number of times of receiving a synchronization packet from the gateway apparatus 13 to the gateway apparatus 13, it is possible to grasp a packet loss situation in wireless communication (for example, as for the sensor node 11b, packet loss occurs once among synchronization packets transmitted three times), and it is effective.

The gateway apparatus 13 transmits the sensor data collected from the sensor node 11a and the time synchronization difference (TDa) to the analysis server 15 via the wide area network 14, and the analysis server 15 analyzes the data received from the gateway apparatus 13. At this time, as for the sensor node 11a, by dividing the time synchronization difference (TDa) by a time from the previous synchronization time to the current synchronization time (synchronization interval time STa; also referred to as a measurement time interval because a synchronization packet is sent for each measurement), the analysis server 15 calculates an error per unit time EDa (=TDa/STa). By multiplying the error EDa by a sensor data measurement time MT, a value of time deviation occurred in the clock unit in the sensor node 11a during measurement, Eta (=EDa×MT) can be estimated.

Here, explanation will be made on a case where the sampling frequency is 400 Hz, and the measurement time is thirty seconds as an example. If ETa described above is 1 ms, the measurement timing of the last measured value is a value measured after 30.001 seconds from the measurement start point of time. In this example, the time from the time of receiving a synchronization packet to the measurement start time is 600 ms, which is a very short time. Therefore, time deviation that occurs during the period can be ignored. The time of a clock unit in a sensor node immediately after start of measurement is synchronized with a high accuracy; time of acquiring the last sensor data can be estimated; and sensor data acquisition intervals can be estimated to be regular intervals without being influenced by time deviation of the sensor node. From these, by performing a resampling process as shown in FIG. 3, it is possible to calculate values of sensor data synchronized with a high accuracy.

Similarly, the analysis server 15 corrects and analyzes sensor data (D_{b0}, D_{b1}, D_{b2}, . . . , D_{bN}, . . . , Dₙ₀, Dₙ₁, Dₙ₂, . . . , D_{nN}) collected from the sensor nodes 11b, . . . , 11n. A specific correction method is similar to the case of the sensor node 11a described above.

As described above, the analysis server 15 is capable of, after correcting synchronization deviation of sensor data of each sensor node, processing the corrected data as synchronized sensor data.

As described above, in the present example embodiment, when sensor data is collected with a plurality of sensor nodes connected to a specific low-power wireless network, time synchronization of the sensor nodes is performed using a synchronization packet immediately before start of measurement. Further, by correcting variation among clocks of the sensor nodes using time difference information at the time of the time synchronization, it becomes possible to collect sensor data with a synchronization accuracy within 1 ms.

Therefore, it becomes unnecessary to implement expensive hardware such as a GPS and an atomic clock for each sensor node, and an effect that cost reduction is possible is obtained.

Further, since it is necessary for a GPS to receive radio waves from a satellite, installation positions of sensor nodes are restricted. In the present example embodiment, however, a GPS is not required. Therefore, the degree of freedom of installation positions of sensor nodes increases, and the restriction that it should be possible to receive radio waves from a satellite does not occur.

### Third Example Embodiment

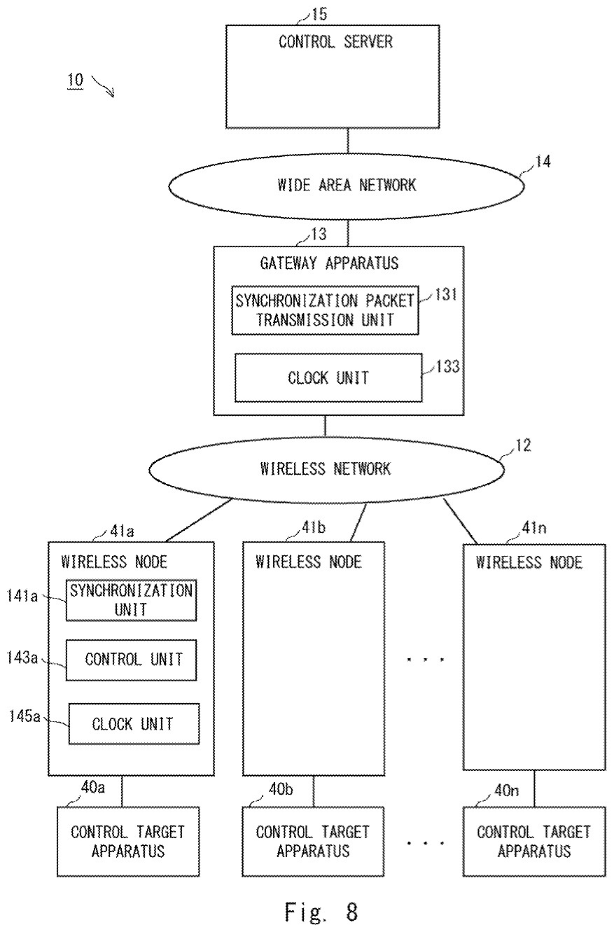

A synchronization control system 10 according to a third example embodiment will be explained with reference to FIG. 8.

In FIG. 8, the same components as the second example embodiment are given the same reference signs as FIG. 4, and description thereof will be appropriately omitted.

In the above example embodiments, collection of synchronized sensor data has been explained. As another example embodiment, a synchronization control system by wireless nodes connected to a specific low-power wireless network will be explained. In this example, each wireless node performs one-off synchronized control at certain time (e.g., turns on the multiple control target apparatuses at once).

FIG. 8 is a block diagram showing a configuration example of synchronization control by a wireless network. In the present example embodiment, wireless nodes 41 are provided instead of the sensor nodes 11. In FIG. 8, each of the wireless nodes 41 is provided with a synchronization unit 141a, a control unit 143a and a clock unit 145a similarly to the sensor nodes 11. Since the synchronization unit 141a and the clock unit 145a are configured similarly to the synchronization unit 141a and the clock unit 145a described above, description thereof will be omitted.

The synchronization packet transmission unit 131 of the gateway apparatus 13 transmits a control start packet showing synchronization time and control start time to wireless nodes 41a, 41b, . . . , 41n. The control unit 143a performs control to cause a control target apparatus 40a to be activated at the control start time indicated in the synchronization packet SP. Similarly, control units 143b, . . . , 143n perform control to cause control target apparatuses 40b, . . . , 40n to be activated at the control start time indicated in the synchronization packet SP. By doing so, it becomes possible to perform control synchronized with a high accuracy within 1 ms for the plurality of control target apparatuses 40a, 40b, . . . , 40n.

Furthermore, as the process procedure in the monitoring system has been described in the various example embodiments described above, the present disclosure can take a form as a synchronization method of a monitoring apparatus, the monitoring apparatus including: a plurality of sensor nodes installed on a structure and configured to measure physical quantities of the structure; and a gateway apparatus communicably connected to the plurality of sensor nodes via a wireless network. In this synchronization method, the gateway apparatus transmits a synchronization packet specifying synchronization time and measurement start time, to the plurality of sensor nodes by broadcast communication; each of the plurality of sensor nodes synchronizes time in the sensor node with the synchronization time indicated in the received synchronization packet, calculates a time synchronization difference which is a difference between the synchronization time indicated in the received synchronization packet and the time in the sensor node before the synchronization, starts measurement of the physical quantities at the measurement start time of the synchronization packet, and transmits the time synchronization difference and a measured value obtained by the measurement to the gateway apparatus; and the gateway apparatus corrects the measured value based on the time synchronization difference, for each sensor node. Other examples are as explained in the various example embodiments described above.

In the above examples, a program can be stored in various types of non-transitory computer-readable media and supplied to computers. The non-transitory computer-readable media include various types of tangible storage media. Examples of the non-transitory computer-readable media include magnetic recording media (for example, a flexible disk, a magnetic tape and a hard disk drive), magneto-optical recording media (for example, a magneto-optical disk), a CD-ROM (read-only memory), a CD-R, a CD-R/W, a DVD (digital versatile disc), a BD (Blu-ray (registered trademark) disc), and semiconductor memories (for example, a mask ROM, a PROM (programmable ROM), an EPROM (erasable PROM), a flash ROM and a RAM (random-access memory)). Further, the program may be supplied to computers by various types of transitory computer-readable media. Examples of the transitory computer-readable media include an electric signal, an optical signal and an electromagnetic wave. The transitory computer-readable media can supply the program to computers via a wired communication channel such as an electric cable and an optical fiber or a wireless communication channel.

The present invention is not limited to the above example embodiments but can be appropriately changed within a range not departing from its spirit. Further, the plurality of examples explained above can be appropriately combined and implemented.

The invention of the present application has been explained with reference to the example embodiments, but the invention of the present application is not limited by the above. Various changes that one skilled in the art can understand can be made in the configurations and details of the invention of the present application within the scope of the invention.

A part or all of the above example embodiments can be described like the following supplementary notes but are not limited to the following supplementary notes.

(Supplementary note 1). A monitoring system comprising:

a plurality of sensor nodes installed on a structure and configured to measure physical quantities of the structure; and

a gateway apparatus communicably connected to the plurality of sensor nodes via a wireless network,

the gateway apparatus including:

synchronization packet transmission means for transmitting a synchronization packet specifying synchronization time and measurement start time, to the plurality of sensor nodes by broadcast communication; and

correction means for correcting each of measured values measured by the plurality of sensor nodes,

each of the plurality of sensor nodes including:

synchronization means for synchronizing time in the sensor node with the synchronization time indicated in the received synchronization packet;

difference calculation means for calculating a time synchronization difference which is a difference between the synchronization time indicated in the received synchronization packet and the time in the sensor node before the synchronization;

measurement means for starting measurement of the physical quantities at the measurement start time of the synchronization packet; and

correction information transmission means for transmitting the time synchronization difference and a measured value measured by the measurement means to the correction means of the gateway apparatus,

wherein the correction means corrects the measured value based on the time synchronization difference, for each sensor node.

(Supplementary note 2). The monitoring system according to note 1, wherein the synchronization packet transmission means transmits the synchronization packet a plurality of times.

(Supplementary note 3). A monitoring system comprising:

a plurality of sensor nodes installed on a structure and configured to measure physical quantities of the structure;

a gateway apparatus communicably connected to the plurality of sensor nodes via a wireless network; and

an analysis server connected to the gateway apparatus via a network,

the gateway apparatus including

synchronization packet transmission means for transmitting a synchronization packet specifying synchronization time and measurement start time, to the plurality of sensor nodes by broadcast communication,

each of the plurality of sensor nodes including:

synchronization means for synchronizing time in the sensor node with the synchronization time indicated in the received synchronization packet;

difference calculation means for calculating a time synchronization difference which is a difference between the synchronization time indicated in the received synchronization packet and the time in the sensor node before the synchronization;

measurement means for starting measurement of the physical quantities at the measurement start time of the synchronization packet; and

correction information transmission means for transmitting the time synchronization difference calculated by the difference calculation means and a measured value measured by the measurement means to the analysis server,

wherein the analysis server includes correction means for correcting the measured value based on the time synchronization difference, for each sensor node.

(Supplementary note 4). The monitoring system according to note 3, wherein the synchronization packet transmission means transmits the synchronization packet a plurality of times.

(Supplementary note 5). A synchronization method of a monitoring apparatus, the monitoring apparatus comprising:

a plurality of sensor nodes installed on a structure and configured to measure physical quantities of the structure; and

a gateway apparatus communicably connected to the plurality of sensor nodes via a wireless network, wherein

the gateway apparatus transmits a synchronization packet specifying synchronization time and measurement start time, to the plurality of sensor nodes by broadcast communication,

each of the plurality of sensor nodes

synchronizes time in the sensor node with the synchronization time indicated in the received synchronization packet,

calculates a time synchronization difference which is a difference between the synchronization time indicated in the received synchronization packet and the time in the sensor node before the synchronization,

starts measurement of the physical quantities at the measurement start time of the synchronization packet, and

transmits the time synchronization difference and the a measured value obtained by the measurement to the gateway apparatus, and

the gateway apparatus corrects the measured value based on the time synchronization difference, for each sensor node.

This application claims priority based on Japanese Patent Application No. 2019-005350 filed on Jan. 16, 2019, the disclosure of which is hereby incorporated in its entirety.

### REFERENCE SIGNS LIST

1 Monitoring system
10 Synchronization control system
11a, 11b, . . . , 11n Sensor node
12 Wireless network
13 Gateway apparatus
14 Wide area network
15 Analysis server
40a, 40b, . . . , 40n Control target apparatus
41 Wireless node
111 Synchronization unit
112 Difference calculation unit
113 Measurement unit
114 Correction information transmission unit
115 Clock unit
131 Synchronization packet transmission unit
132 Correction unit
133 Clock unit
141 Synchronization unit
143 Control unit
145 Clock unit

What is claimed is:

1. A monitoring system comprising:
a plurality of sensor nodes installed on a structure and configured to measure physical quantities of the structure; and
a gateway apparatus communicably connected to the plurality of sensor nodes via a wireless network,
the gateway apparatus including:
synchronization packet transmission unit configured to transmit a synchronization packet specifying synchronization time and measurement start time, to the plurality of sensor nodes by broadcast communication; and
correction unit configured to correct each of measured values measured by the plurality of sensor nodes,
each of the plurality of sensor nodes including:
synchronization unit configured to synchronize time in the sensor node with the synchronization time indicated in the received synchronization packet;
difference calculation unit configured to calculate a time synchronization difference which is a difference between the synchronization time indicated in the received synchronization packet and the time in the sensor node before the synchronization;
measurement unit configured to start measurement of the physical quantities at the measurement start time of the synchronization packet; and
correction information transmission unit configured to transmit the time synchronization difference and a measured value measured by the measurement unit to the correction unit of the gateway apparatus,
wherein the correction unit corrects the measured value based on the time synchronization difference, for each sensor node.

2. The monitoring system according to claim 1, wherein the synchronization packet transmission unit transmits the synchronization packet a plurality of times.

3. A monitoring system comprising:
a plurality of sensor nodes installed on a structure and configured to measure physical quantities of the structure;
a gateway apparatus communicably connected to the plurality of sensor nodes via a wireless network; and
an analysis server connected to the gateway apparatus via a network,
the gateway apparatus including
synchronization packet transmission unit configured to transmit a synchronization packet specifying synchronization time and measurement start time, to the plurality of sensor nodes by broadcast communication,
each of the plurality of sensor nodes including:
synchronization unit configured to synchronize time in the sensor node with the synchronization time indicated in the received synchronization packet;
difference calculation unit configured to calculate a time synchronization difference which is a difference between the synchronization time indicated in the received synchronization packet and the time in the sensor node before the synchronization;
measurement unit configured to start measurement of the physical quantities at the measurement start time of the synchronization packet; and
correction information transmission unit configured to transmit the time synchronization difference calculated by the difference calculation unit and a measured value measured by the measurement unit to the analysis server,
wherein the analysis server includes correction unit configured to correct the measured value based on the time synchronization difference, for each sensor node.

4. The monitoring system according to claim 3, wherein the synchronization packet transmission unit transmits the synchronization packet a plurality of times.

5. A synchronization method of a monitoring apparatus, the monitoring apparatus comprising:
a plurality of sensor nodes installed on a structure and configured to measure physical quantities of the structure; and
a gateway apparatus communicably connected to the plurality of sensor nodes via a wireless network, wherein
the gateway apparatus transmits a synchronization packet specifying synchronization time and measurement start time, to the plurality of sensor nodes by broadcast communication,
each of the plurality of sensor nodes
synchronizes time in the sensor node with the synchronization time indicated in the received synchronization packet,
calculates a time synchronization difference which is a difference between the synchronization time indicated in the received synchronization packet and the time in the sensor node before the synchronization,
starts measurement of the physical quantities at the measurement start time of the synchronization packet, and
transmits the time synchronization difference and the measured value obtained by the measurement to the gateway apparatus, and
the gateway apparatus corrects the measured value based on the time synchronization difference, for each sensor node.
